(19) United States
(12) Patent Application Publication
(10) Pub. No.: US 2014/0285034 A1
(43) Pub. Date: Sep. 25, 2014

(54) Linear motor with contactless energy transfer

(71) Applicant: Technische Universiteit Eindhoven, Eindhoven (NL)

(72) Inventors: David Christian Johannes Krop, Heerlen (NL); Jacob Willem Jansen, Waarle (NL); Elena Andreevna Lomonova, Eindhoven (NL)

(21) Appl. No.: 14/354,207

(22) PCT Filed: Oct. 23, 2012
(86) PCT No.: PCT/EP2012/070971

§ 371 Date: Apr. 25, 2014

Related U.S. Application Data
(60) Provisional application No. 61/552,011, filed on Oct. 27, 2011.

(51) Int. Cl. H02K 41/03

(52) U.S. Cl. CPC H02K 41/031
USPC 310/12.18

(57) ABSTRACT

An integrated electromagnetic energy conversions device is provided that includes a synchronous or brushless linear (SoBL) motor, and a transformer, where the transformer is integrated electromagnetically and topologically with the SoBL motor, where an electromagnetic field orientation of the transformer is perpendicular to an electromagnetic field orientation of the SoBL motor, where a magnetic-field decoupling between the SoBL motor and the transformer is provided and a position independent magnetic coupling of the transformer is provided, where the integrated SoBL motor and the transformer operate simultaneously in a motor and transformer mode.

### FIELD OF THE INVENTION

The present invention relates generally to synchronous or brushless linear motors and generators.

### BACKGROUND OF THE INVENTION

In many industrial applications linear electric machines are used to move or transport objects. Apart from the movement itself, it is in the majority of the cases required that not only the force is delivered to the payload, but also electric energy. To power the motor and the payload, a moving cable bundle is attached to the translator. The moving cable is not only prone to abrasion, it also introduces—especially in high precision applications undesired mechanical distortion. In the current state of the art, separate moving transformers have been connected to existing linear motors. However, this leads to a much bulkier system and significantly reduces the force density of the complete system.

In long-stroke applications moving-coil machines are favorable, in order to avoid complex commutation algorithms for the phase currents. The disadvantage of moving-coil machines is the moving cable bundle that has to be dragged along during the motion. Not only is the cable bundle susceptible to wear, it also introduces additional mass, stiffness and hysteresis. Especially in high-precision applications, these cause additional undesired dynamical distortion that require complex control algorithms to compensate for these effects. Moreover, if additional electronic apparatus is mounted to the mover, an extra moving cable is necessary to provide the power.

Contactless Energy Transfer (CET) provides a solution to these problems. The wirelessly transferred energy can be used to simultaneously power the motor and the attached apparatus. Separate, non-integrated CET systems are proposed that can be used in conjunction with any linear machines. The major drawback of this approach is that it results in a bulkier system. The overall force density of the system deteriorates drastically. An integrated solution has been attempted, where the machine can either operate in transformer or motor mode, however simultaneous operation is not possible. In a further attempt simultaneous operation was made possible, where the primary core is shared with the stator of the linear motor, but the secondary pick up coil has a separate core that is dragged along, behind the mover of the motor. Furthermore, the magnetic coupling between the primary and secondary is position dependent due to the varying reluctance seen by the primary coil. In another attempt the CET was integrated in the end teeth of the linear machine, where two air gaps are present in the structure. Due to these air gaps, leakage paths are created that decrease the performance of both motor and energy transfer.

What is needed is a contactless energy system that overcomes the disadvantages of the moving transformer needed for the power transfer and eliminates the need for a separate contactless energy transfer system.

### SUMMARY OF THE INVENTION

To address the needs in the art, an integrated electromagnetic energy conversions device is provided that includes a synchronous or brushless linear (SoBL) motor, and a transformer, where the transformer is integrated electromagnetically and topologically with the SoBL motor, where an electromagnetic field orientation of the transformer is perpendicular to an electromagnetic field orientation of the SoBL motor, where a magnetic-field decoupling between the SoBL motor and the transformer is provided and a position independent magnetic coupling of the transformer is provided, where the integrated SoBL motor and the transformer operate simultaneously in a motor and transformer mode.

According to one aspect of the invention, the topology comprises a transformer integrated with the SoBL motor.

In another aspect of the invention, a cross-sectional shape of the SoBL motor can include circular, rectangular, elliptical and polygonal.

According to a further aspect of the invention, the SoBL motor includes an isotropic, low-conductive soft-magnetic composite core material.

In one aspect of the invention, the SoBL motor includes a synchronous brushless motor, wherein the motor includes dc excitation-coils array or a permanent magnet array for magnetic-field excitation.

According to another aspect of the invention, a cross-section of the device includes a first transformer primary coil and a first transformer secondary coil, where a stator shaft is disposed between the first transformer primary coil and the first transformer secondary coil, where a permanent magnet array or dc excitation-coil array is disposed between the stator shaft, where an air gap is disposed between the permanent magnet array or dc excitation-coil array and the first transformer secondary coil, and a soft-magnetic core disposed between the first transformer secondary coil and a second transformer primary coil, where a second transformer secondary coil is disposed between the soft-magnetic core and the second transformer primary coil, where the soft-magnetic core includes an array of interleaved phase coils, wherein the second transformer primary coil is a return path for the first transformer primary coil, where the second transformer secondary coil is a return path for the first transformer secondary coil.

### BRIEF DESCRIPTION OF THE DRAWINGS

FIG. 1a shows a perspective cutaway view of the topology of the tubular synchronous or brushless linear motor with integrated contactless energy transfer, according to one embodiment with permanent magnet array of the invention.

FIGS. 1b-1c show perspective cutaway views of the topology of the tubular synchronous or brushless linear motor with integrated contactless energy transfer with a CET (b) and TSM (c) parts with flux (−) and current orientation (−−), according to one embodiment with permanent magnet array of the invention.

FIG. 3. shows a 2D Fourier model of the CET divided into circular regions, according to one embodiment with permanent magnet array of the invention.

FIG. 4 shows a 2D Fourier model of the TSM divided into rectangular regions, according to one embodiment with permanent magnet array of the invention.

FIGS. 5a-5b show the influence of the number of slits (N_{sec}) and slit width ratio (α) on the thrust force (a) and eddy losses (b), according to one embodiment with permanent magnet array of the invention.

FIGS. 6a-6b show the influence of the magnet height (rm) and slot height (rs) on the thrust force (a) and eddy losses (b), according to one embodiment with permanent magnet array of the invention.

FIG. 7 shows a measurement circuit for the determination of the magnetic coupling, according to one embodiment with permanent magnet array of the invention.

FIG. 8 shows the relative variation in magnetic coupling of the CET transformer as function of displacement and phase current density, according to one embodiment with permanent magnet array of the invention.

FIGS. 9a-9b show a double-sided rectangular or polygonal topology of the translator, according to one embodiment of the invention.

FIGS. 10a-10b show a double-sided circular topology of the translator, according to one embodiment of the invention.

FIGS. 11-12 show double-sided structures with air gaps, according to embodiments of the invention.

FIG. 13 shows segmented primary coils for double-sided structure with air gaps, according to one embodiment of the invention.

FIG. 14 shows segmented primary coils for a double-sided structure with air gaps, according to one embodiment of the invention.

FIG. 15 shows a topology with additional 2 transformer cores at the ends, according to one embodiment of the invention.

### DETAILED DESCRIPTION

The current invention provides a magnetically and topologically integrated solution, which operates simultaneously in transformer and motor mode. The invention includes a topology that combines a tubular synchronous machine (TSM) with a high frequency coaxial transformer. The TSM is a specific class of SoBL machine. The field orientation of the coaxial transformer is perpendicular to the one of the TSM. Therefore, the core includes isotropic, nonlinear, low conductive soft-magnetic composite (SMC) material. The orthogonally, superimposed magnetic fields of the motor and transformer operate at different frequencies and give rise to a highly 3 dimensional magnetic field distribution in the core.

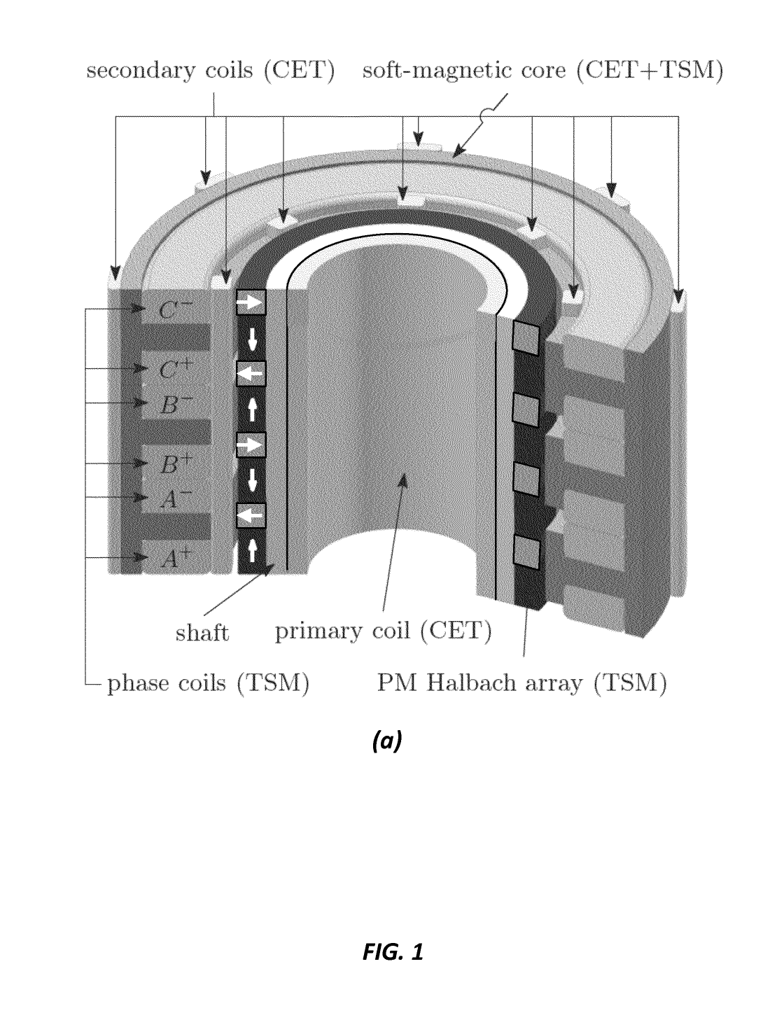

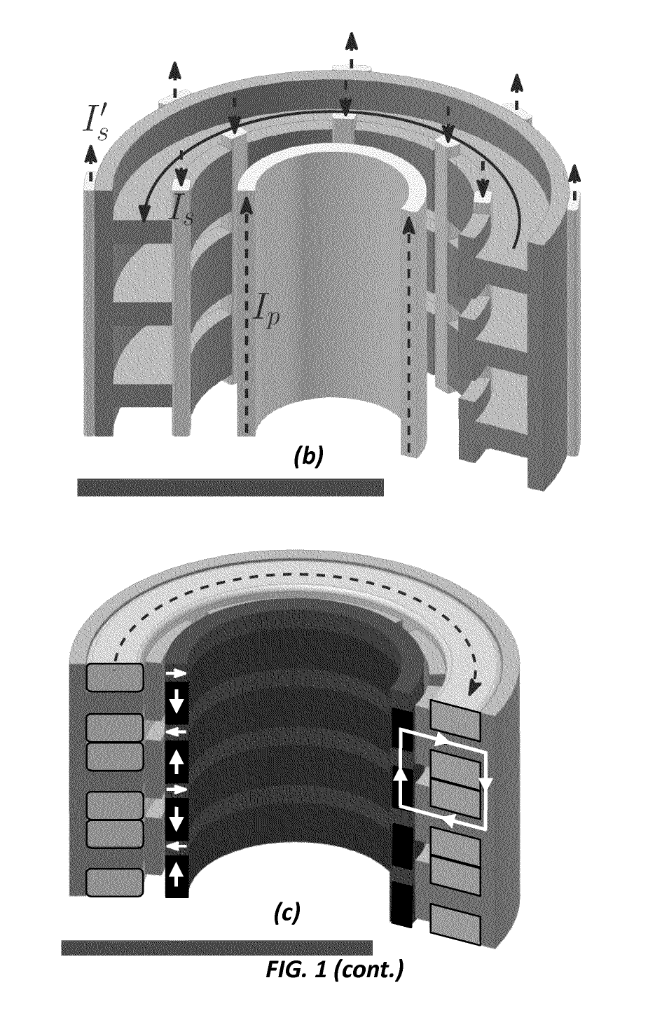

One embodiment of the topology of the TSM with integrated CET is shown in FIGS. 1a-1c. The structure has periodicity in the z-direction. The topology is a combination of a coaxial transformer and a tubular linear SoBL motor. The CET is fed through a full bridge converter with a resonant capacitor to compensate for the leakage inductance. At the secondary the voltage is rectified in order to create a DC-bus (FIG. 2).

According to the current embodiment, the CET part of the machine includes the components shown in FIGS. 1b-1c. The current orientation in the coils and flux orientation in the core of the coaxial transformer are shown. The primary is mounted inside the stationary shaft. The return path of the primary is not shown in FIG. 1b. The current path of the primary closes beyond the cofines of the core, but the return path is not shown in FIG. 1b. The turns of the secondary coil are placed in equidistantly spaced slits in the pole shoes of the mover teeth of the TSM. The return paths of the secondary are the conductors outside of the core. When an alternating current passes through the primary coil of the CET in the positive z-direction a magnetic field that is confined to the rφ-plane is generated in the soft-magnetic core. The magnetic field originating from the primary coil is linked with the secondary coil. If a load is connected to the secondary coil a current flows in the direction so as to oppose the magnetic field.

This situation is indicated with arrows in FIG. 1b. The stainless steel shaft that provides the mechanical connection between the components of the machine is not shown. The relative permeability and conductivity of the shaft influence the behavior of the CET. To guarantee a high magnetic coupling of the transformer the shaft has to have low permeability. Otherwise, the flux generated by the primary is short circuited through the shaft and the leakage flux increases. A high electric conductivity would lead to additional heat generation due to eddy currents inside the shaft at the chosen frequency.

Turning now to the TSM, the parts, flux and current orientation of the TSM are shown in FIG. 1b. The chosen SoBL motor topology has three phase slots per four poles and concentrated phase windings. In this example, the total number of slots is 9. The magnet array is of the quasi-Halbach type. The quasi-Halbach array is necessary in order to obtain a proper magnetic loading of the SoBL motor, since a soft-magnetic shaft would create a magnetic short circuit for the flux of the primary transformer coil. The main flux of the TSM is confined to the rz-plane. Because the CET flux and TSM flux are spatially perpendicular, decoupling between the TSM and CET functionality is realized. However, at the slits of the secondary windings fringing of the motor flux occurs. Moreover, at these positions the fluxes of the CET and TSM are not perpendicular anymore. This will result in higher local saturation of the structure. Furthermore, the slits result in a smaller effective circumferential length of the air gap, which causes the generated force of the TSM to be lower compared to the same conventional TSM without slits.

According to some embodiments of the invention, a soft-magnetic core in the SoBL motor is used simultaneously as a soft-magnetic core for the transformer. The magnetic field orientations of the SoBL motor and the transformer are perpendicular to each other, where cross coupling between the two functionalities is avoided. Due to the perpendicular magnetic field orientation the magnetic coupling is position independent. In various aspects of the invention, machines can operate longer without the need of additional maintenance (exchanging the cables). Higher precision can be obtained since the undesired mechanics of the cable are removed. The invention can be applied to machines for the high precision-industry, medical, robotics and machine tooling applications and transport.

Moreover, the invention provides various advantages in general, such as less mechanical distortion, lower mass on the moving platform, less maintenance, more accurate positioning and no moving cables. Furthermore, electric energy can be delivered to the moving platform to power other electrical devices.

Regarding the soft-magnetic core material in this exemplary embodiment, the chosen operating frequency of the CET is 10 kHz. The material of the core, therefore has to have a low electric conductivity and preferably low hysteresis losses. Furthermore, the material must not saturate due to the high flux density of the magnets. Due to the orthogonal field orientation of the CET and the TSM, the material also has to be isotropic. Therefore, the SMC material is the only viable candidate for the core material. In this example, the most suitable SMC grade is Somaloy 130i 5P, because it has a relatively high saturation level and a low electric conductivity. To keep the core losses within acceptable values, the flux density component of the CET must be low. For the Somaloy 130i 5P grade SMC material the core losses are 24.7 Wkg⁻¹ for 0.1 T at 10 kHz. For the same flux density at 25 kHz the core losses are 84.7 Wkg⁻¹.

Regarding the modeling techniques, due to the orthogonality of the fluxes and the isotropy of the SMC, the low flux density value of the component of the CET, compared to the flux density component of the TSM, has little impact on the total flux density inside to core. The magnitude of the total flux density is determined by the vector sum of the individual flux density components:

|B|=\sqrt{B_{c}²+Bₘ²} (1)

where B_{c} is the magnitude of the flux density component of the CET and Bₘ is the magnitude of the flux density component of the TSM. B_{c} has been fixed to 0.1 T to keep the core losses low. The flux density component of the TSM, Bₘ, has been set to 1.3 T. Substitution in (1) yields 1.304 T for the total flux density in the core. This is an increase of 0.3% compared to the flux density of the TSM only. This justifies the use of two separate 2D Fourier models. The modeling of the system will be the topic of the subsequent description.

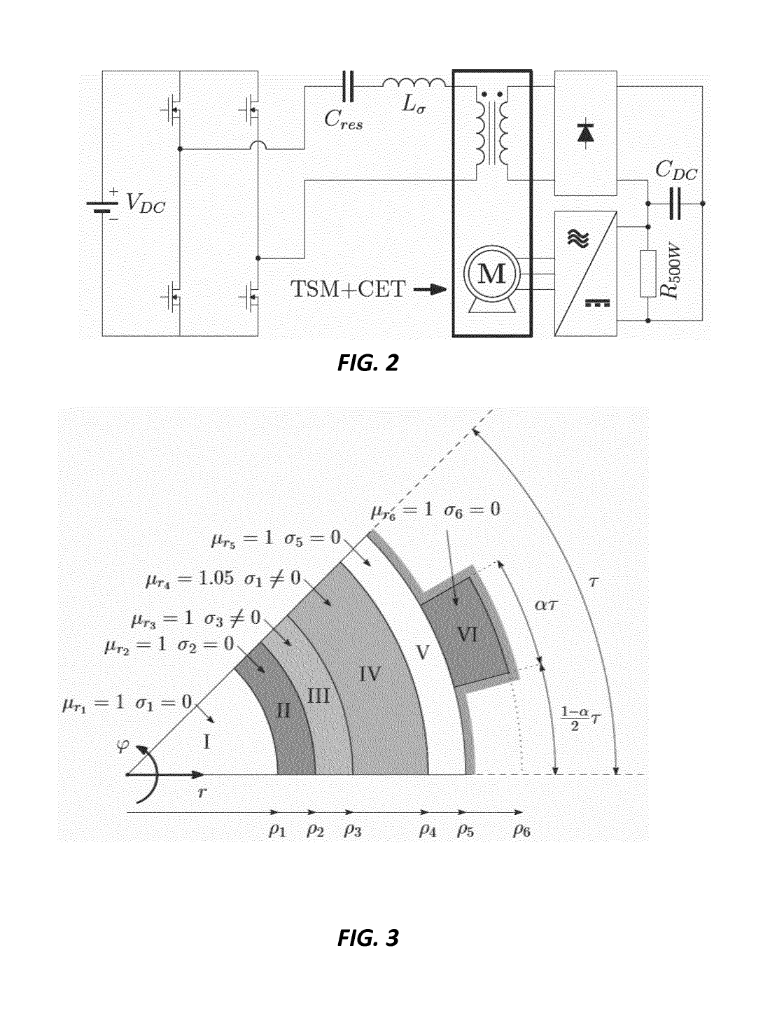

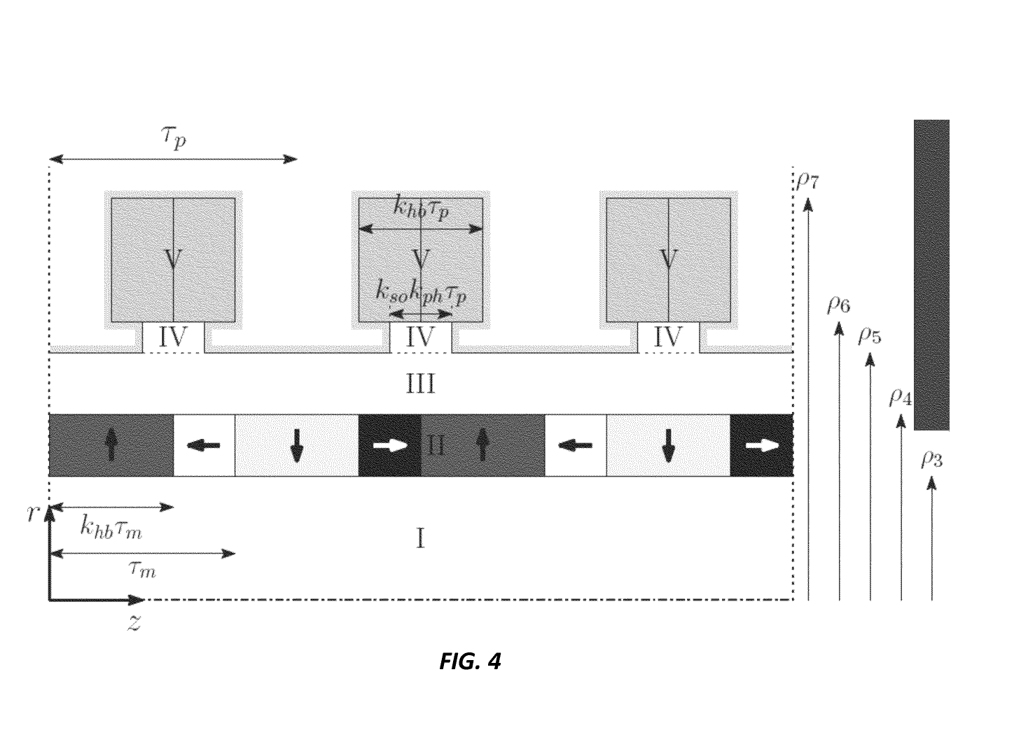

Also, a maximum allowable temperature has been defined. The temperature distribution inside the machine is monitored by means of a 3D steady state thermal equivalent circuit model. A parametric sweep has been conducted for the complete design space of the problem. The magnet height (ρ₄-ρ₃), phase slot height (ρ₇-ρ₆), k_{hb}, kₚₕ, kₛₒ, α, the current density of the CET (J_{c}) and the current density in the phases of the TSM (Jₘ) have been varied during the sweep (FIG. 3 and FIG. 4).

The remaining parameters have been given fixed values. Two designs with different objectives have been realized. In the first design the thrust force is maximized and in the second one the total power loss (including copper losses in the windings and core losses) is minimized. The resulting designs that satisfy the constraints are listed in TABLE I.

TABLE I
OPTIMAL DESIGNS.

| | optimal | optimal | |
|---|---|---|---|
| Parameter | design 1 | design 2 | Unit |
| α | 0.1 | 0.1 | — |
| k_{hb} | 0.3 | 0.34 | — |
| kₚₕ | 0.62 | 0.68 | — |
| kₛₒ | 0.3 | 0.42 | — |
| ρ1 | 10 | 12.5 | mm |
| ρ2 | 13 | 15.5 | mm |
| ρ3 | 16 | 18.5 | mm |
| ρ4 | 22 | 23 | mm |
| ρ5 | 23 | 24 | mm |
| ρ6 | 26 | 27 | mm |
| ρ7 | 37 | 37 | mm |
| ρ8 | 40 | 40 | mm |
| Fₚ | 368.6 | 250.1 | N |
| Fᵣ | 1.9 | 4.9 | % |
| Pₘ(loss) | 37.9 | 22.9 | W |
| P_{c}(loss) | 11.2 | 7.1 | W |
| Jₘ | 2 | 2 | Amm⁻² |
| J_{c} | 4 | 3 | Amm⁻² |
| Tₘ | 79.6 | 59.3 | ° C. |
| Tₚ | 92.6 | 66.9 | ° C. |
| Bₘ | 1.22 | 1.3 | T |

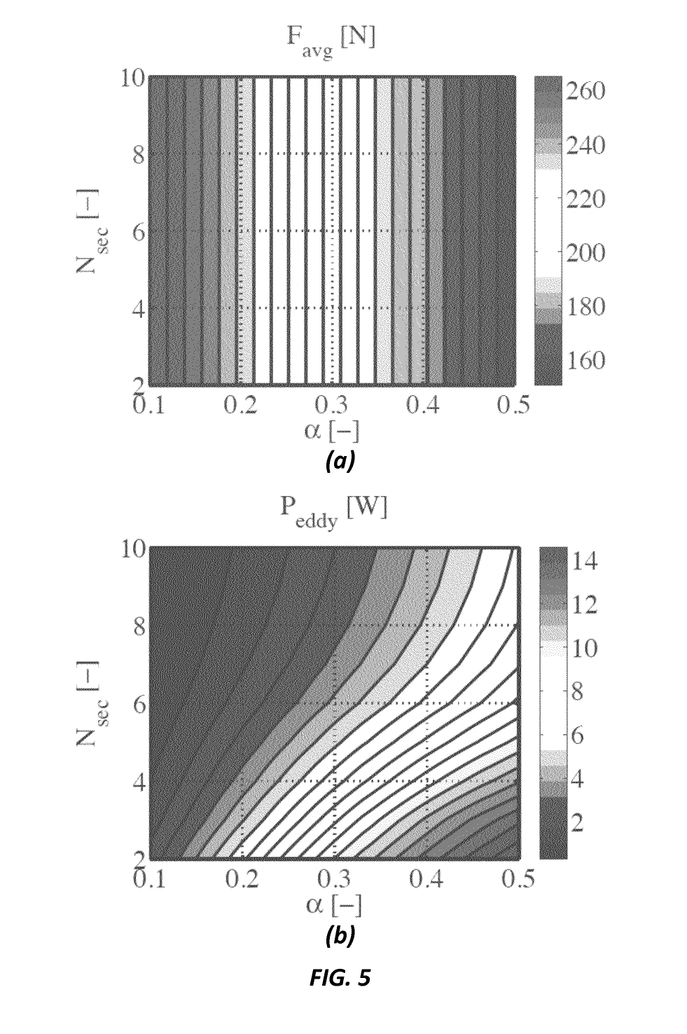

In order to gain more insight in how the geometrical parameters influence the behavior of the TSM and CET in the integrated topology, the results of a parametric sweep of the most important parameters on the average force and eddy current losses are given separately. First, the influence of the number of slits (N_{sec}) and the slit width ratio (α) on the thrust force and the total eddy losses has been examined. Secondly, the effect on the thrust force and eddy losses due to the slot and magnet height has been studied. FIG. 5a shows the influence of the number of secondary slits and slit width ratio (α) on the average trust force of the TSM. The total eddy losses are shown in FIG. 5b. The current density in the primary and secondary coil of the transformer is J_{c}=1 Amm⁻² at 10 kHz. From FIG. 5a it can be seen that the thrust force is unaffected by the number of slits and has a linear dependency on α, the reason being that the fringing effect near the slits has been neglected in the TSM model. In practice, the number of slits does influence the force, since more slits result in a smaller slit width, which affects the fringing flux. As can be observed in FIG. 5b, the eddy current losses can be reduced by lowering α c.q. increasing the number of slits. More slits lead to a more circumferentially distributed secondary current, that results in a lower spatial harmonic content of the eddy current distribution inside the conductive materials. In other words, the value of the coefficients aₙₖ and bₙₖ in (12) become smaller for n>0. When there are more than 8 slits the relative decrease in power loss is less significant if the number of slits is increased further.

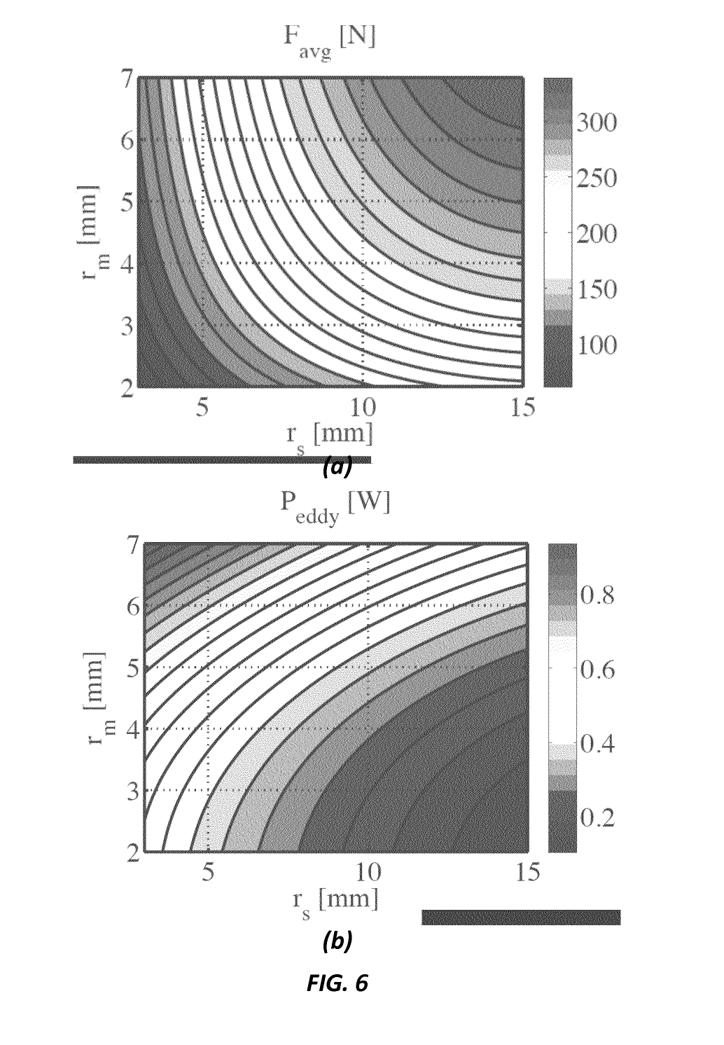

The influence of the magnet height (rₘ), or magnetic loading, and the phase slot height (rₛ), the electric loading, on the force and the eddy losses is shown in FIG. 6a and FIG. 6b, respectively. The number of slits has been set to 8 and the slit width ratio has been fixed at 0.1. Increasing the slot and magnet height results in a higher thrust force, since both the electric and the magnetic loading are increased. The relative gain in force becomes less significant if the magnet or slot height is increased further. Increasing the slot and the magnet height causes the volume of the conductive material to increase. Evidently, this leads to higher eddy current losses when the current density in the transformer coils remains constant.

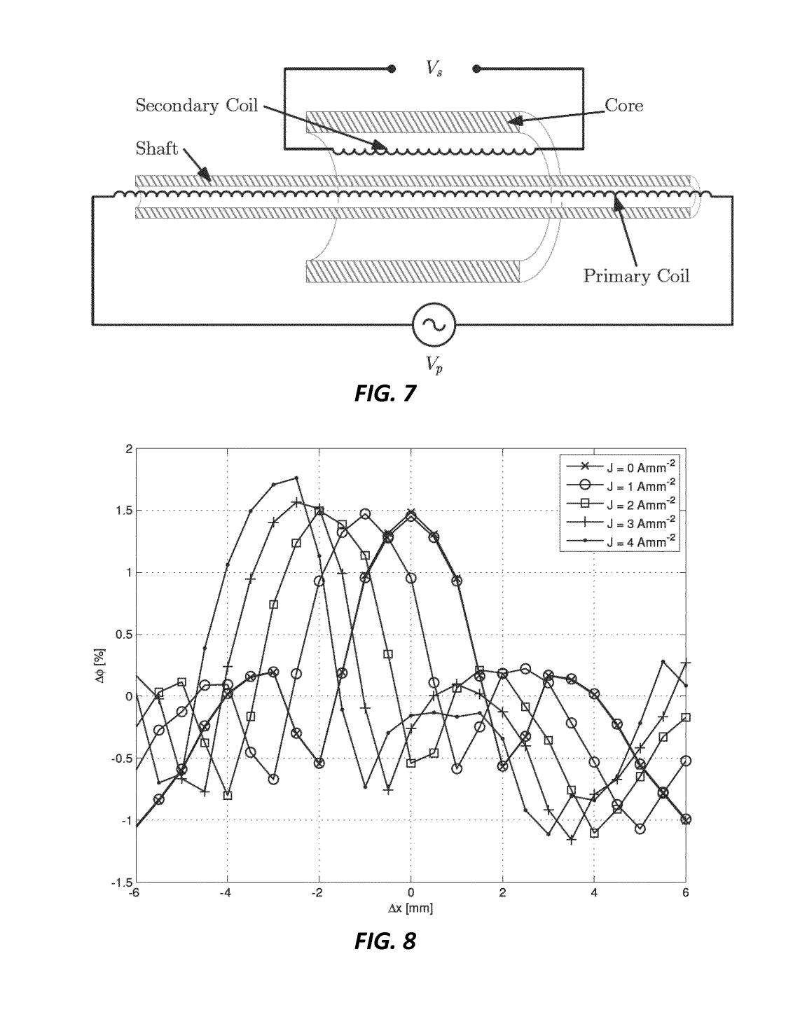

Regarding the FEA model, magnetsostaic 3D model that incorporates the non-linear SMC and the part of the CET that is not encircled by the mover core of the machine has been implemented in FEA to investigate how the CET behaves under full load conditions of the FSM. The commercially available FEA package Flux 3D 14.1 from Cedrat has been used for the analysis. Because of the periodicity of the structure in circumferential direction, only one-eighth of the machine needs to be modeled. The FEA model is used to determine the position dependency of the magnetic coupling as a function of displacement under different load conditions of the TSM. To determine the relative variance in the magnetic coupling between the primary and secondary coil of the CET the amount of magnetzation flux due to current in the primary coil is calculated. The terminals of the secondary coil of the CET are left open and the flux linkage of the secondary coil is measured. This situation is shown in FIG. 7.

The commutation of the phase currents is taken into account during the simulation. The RMS phase coil current density is varied from 0 to the maximum value of 3 Amm⁻². The position and phase current density dependent variance in the flux linkage is shown in FIG. 8. It can be seen that the maximum variance in the coupling varies between −1.1% and 1.7%. As the phase current increases, the flux density in the SMC increases, which causes a spatial redistribution of the local workings point on the BH-curve of the material. This redistribution causes the amplitude of the curve to change and results in an apparent phase shift.

The effect is that the overall permeability of the SMC drops and, accordingly, the coupled CET flux drops as well. The leakage flux outside the mover, however, remains unchanged. Therefore, the magnetic coupling decreases also as the phase current increases. Nevertheless, the decrease in coupling is very low. In practice, the average coupling will be lower because the stator of the machine will be longer than simulated in the FEA. From FIG. 8 it can be concluded that the magnetic coupling is nearly position and load independent, since the variation in position and loading on the coupling is not significant.

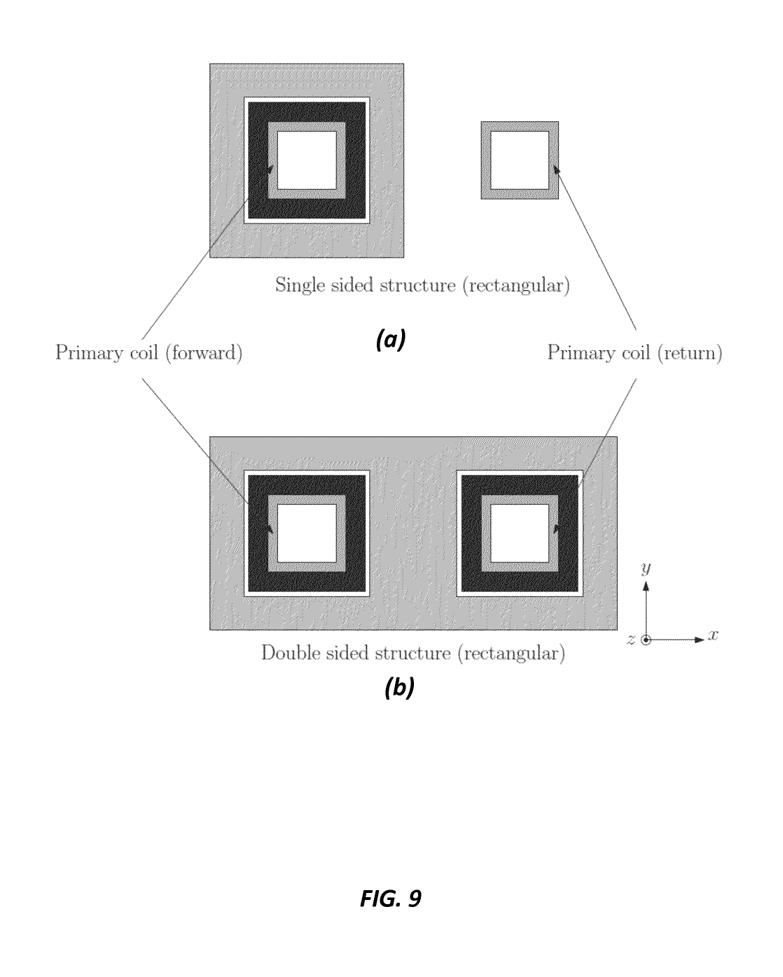

Many topological variations of the invention are possible. The circular shape of the translator could be changed from tubular to rectangular, ellipsoidal, or polygonal as shown in FIG. 9a.

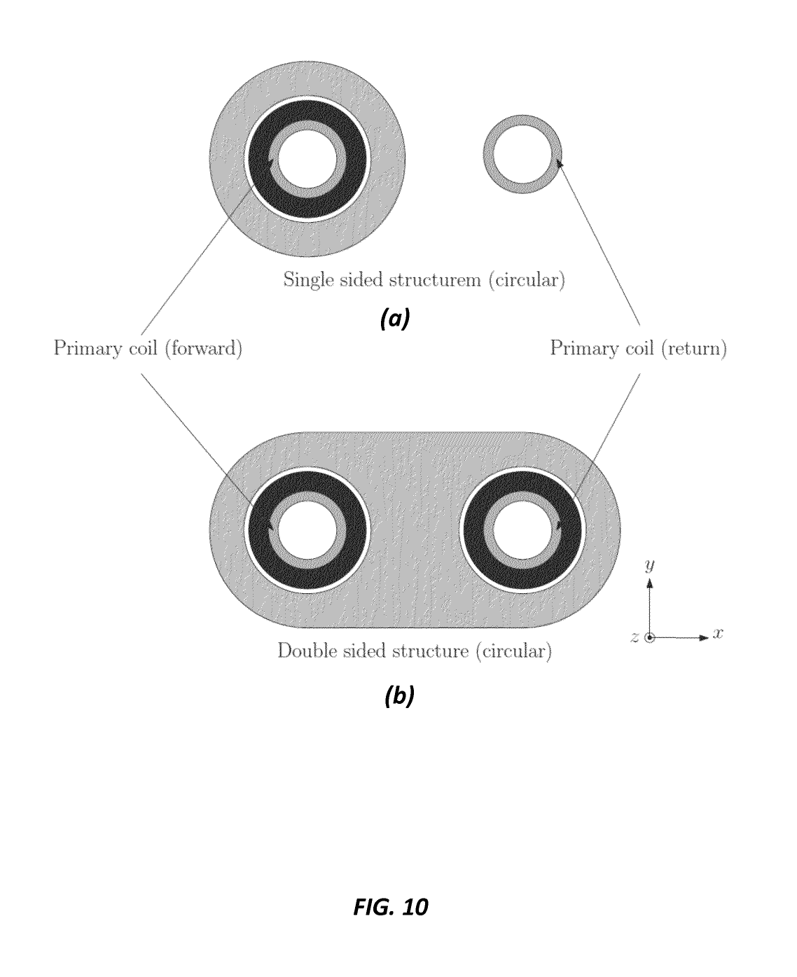

This does not change the working principle of the invention. Embodiments can be applied to both commutated and non-commutated machines, i.e. long and short stroke machines. There are, however, variations of the topology that in certain application lead to a better performance. The invention can also be applied as a double-sided structure as shown in FIGS. 9b-10b.

By applying a double-sided structure the primary coil is used more effectively, since the return path is also encompassed by soft-magnetic core material. According to one embodiment, a double-sided structure comprises two SoBL motors running in parallel, which could share the same structural translator but they could also be further apart in separate structural bodies.

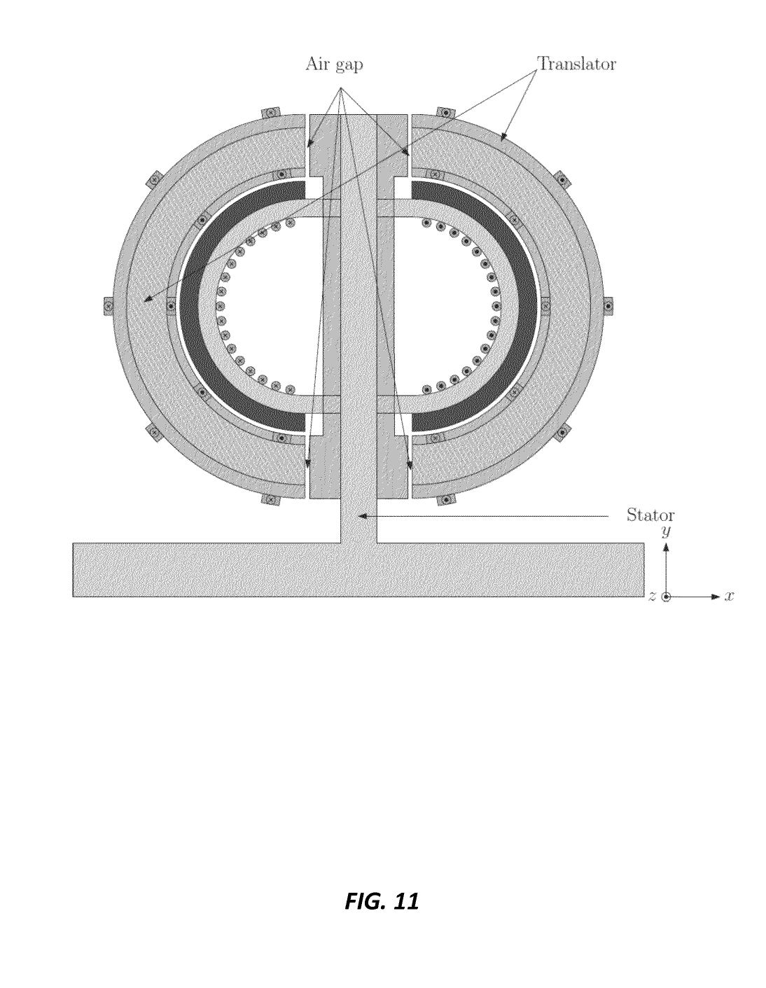

Another embodiment of the double-sided topology having a circular shape is shown in FIGS. 11a-11b. Contrary to the previous structure, the stator can be supported over the full length of the stator, which extends the stroke because bending of the stator rod is prevented. This embodiment, however, has small air gaps in the soft-magnetic core.

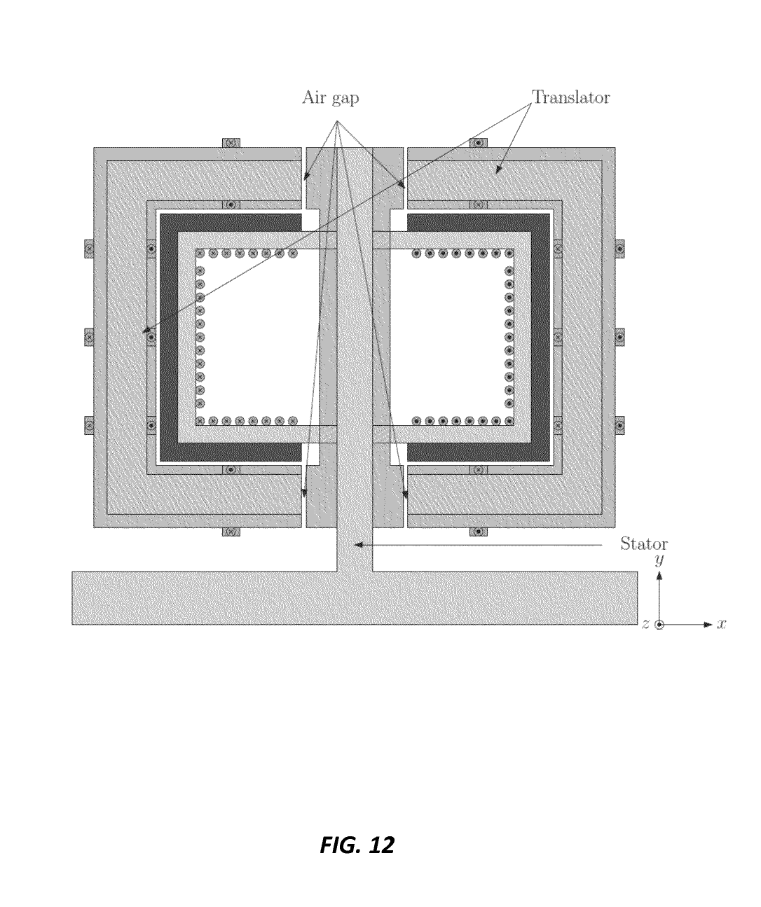

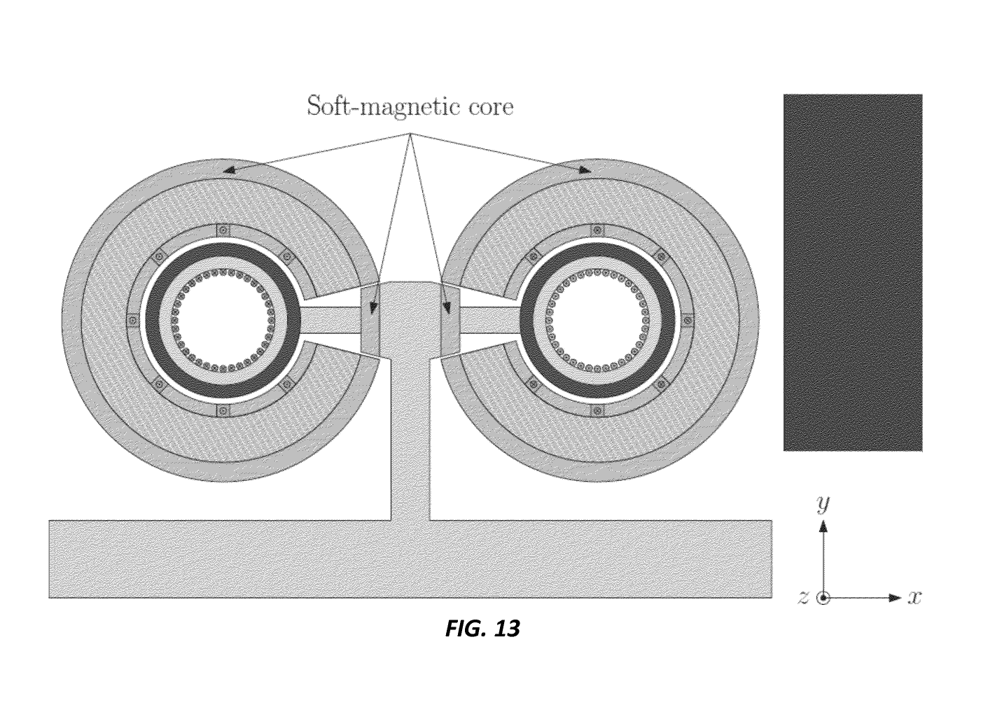

Othervariants of this structure are shown in FIG. 12 and FIG. 13.

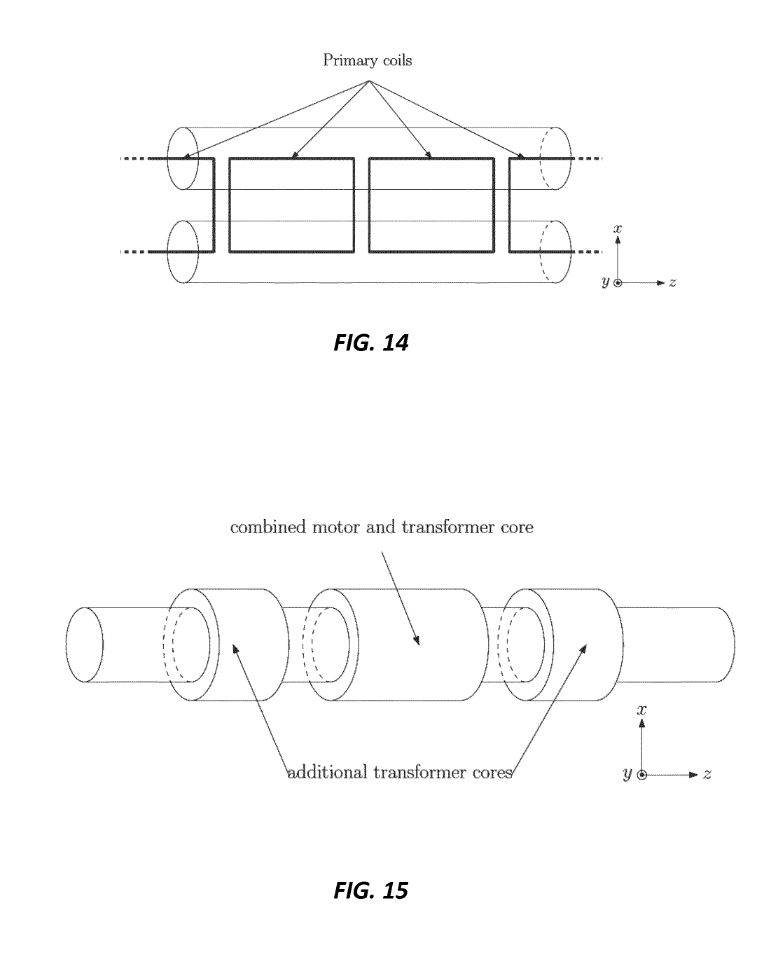

The double-sided structures with air gaps allow the primary coil to be divided into segments as shown in FIG. 14. Depending on the position of the translator appropriate primary coils can be switched on and off. Only coils encompassed by the translator core have to be energized. Thus, the power losses in the primary coils can be reduced significantly.

Additional soft-magnetic cores can be added to the ends of the soft-magnetic part of the translator, in order to increase the amount of power that can be transferred. Alternatively, the SoBL motor and the transformer function could also be separated in this manner. This concept is shown in FIG. 5

Alternative magnetization patterns, other than the quasi-Halbach magnetization, can be applied. Skewing of the magnets or the soft-magnetic core can be applied to obtain lower force ripples.

The use of bonded magnets or a non-conductive material for the shaft (e.g., ceramics) will reduce the losses of the contactless energy transfer.

In conclusion, a novel, fully integrated solution of a contactless energy transfer (CET) system in a tubular synchronous permanent magnet machine (TSM) is provided. Due to the complexity and size of the structure only transient 3D finite element analysis (FEA) can be applied to accurately quantify the behavior of the system. The computationally demanding FEA is not suitable as a design tool. Therefore, assumptions have been made to reduce the complexity of the analysis. Based on these assumptions two separate Fourier techniques have been proposed that can model either function, CET or TSM, of the system. Due the orthogonal orientation of the field distribution of the CET and the TSM both functionalities are decoupled. The orthogonal field distribution also allows two separate models to be used, all the more because the influence of the CET magnetic field on the total magnetic field is negligible if the amplitude of the CET field is low. The Fourier models have been applied to determine the eddy current losses in the magnets due to the transformer leakage field of the CET. Furthermore, the force profile of the machine could be determined and the effects of integration on both the CET and the TSM could be calculated. The models have been applied in a parametric sweep to determine the topology with the highest thrust force and the topology with the lowest losses, that both satisfy the design constraints. The energy transfer behavior of the topology with the lowest losses has been implemented in a 3D transient FEA model. The magnetic coupling as a function of position and phase current has been calculated and showed that the coupling can be considered position and phase current independent, since their influence on the coupling is negligible.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the invention is equally applicable to the entire class of electrical machines to which the tubular PM machine is embodied. The electromagnetic field in the machine can originate from permanent magnets and excited dc coils alike. The tubular PM machine is presented as an example because it enables strong electromagnetic modeling and good electromagnetic behavior in the test set-up. Further, the structure does not necessarily have to be coaxial for the general working principle. In another variation, there is no restriction on the frequency range, where the frequency range is determined by the available volume of the core for a given amount of power transfer and the amount of heat dissipation due to core losses. For example, in commonly applied soft-magnetic materials for power solutions the frequency range is typically below 200 kHz. For a transformer to work the frequency must be non-zero. In the material applied in the specific design presented above, the transformer has a frequency range of 1-10 kHz. In a further variation, the return path of the transformer primary coil closes beyond the return path of the transformer secondary coil. For the example embodiment, a PM quasi-Halbach array is applied to enhance the force density of the SoBL motor, it is, however, not essential for the general working principle for the PM array to be of the quasi-Halbach type when applied instead of dc excitation-coil.

All such variations are considered to be within the scope and spirit of the present invention as defined by the following claims and their legal equivalents.

What is claimed:

1. An integrated electromagnetic energy conversion device comprising:
a. a synchronous or brushless linear (SoBL) motor; and
b. a transformer, wherein said transformer is integrated electromagnetically and topologically with said SoBL motor, wherein an electromagnetic field orientation of said transformer is perpendicular to an electromagnetic field orientation of said SoBL motor, wherein a magnetic-field decoupling between said SoBL motor and said transformer is provided, wherein a position independent magnetic coupling of said transformer is provided, wherein said integrated SoBL motor and said transformer operate simultaneously in a motor and transformer mode.

2. The device of claim 1, wherein said topology comprises a transformer integrated with said SoBL motor.

3. The device of claim 1, wherein a cross-sectional shape of said SoBL motor is selected from the group consisting of circular, rectangular, elliptical and polygonal.

4. The device of claim 1, wherein said SoBL motor comprises an isotropic, low-conductive soft-magnetic composite core material.

5. The device of claim 1, wherein said SoBL motor comprises a brushless motor, wherein said brushless motor comprises a permanent magnet array or a dc excitation-coil array for magnetic-field excitation.

6. The device of claim 1, wherein a cross-section of said device comprises:
a. a first transformer primary coil and a first transformer secondary coil, wherein a stator shaft is disposed between said first transformer primary coil and said first transformer secondary coil, wherein a permanent magnet array or dc excitation-coil array is disposed between said stator shaft, wherein an air gap is disposed between said permanent magnet array or dc excitation-coil array and said first transformer secondary coil; and
b. a soft-magnetic core disposed between said first transformer secondary coil and a second transformer primary coil, wherein a second transformer secondary coil is disposed between said soft-magnetic core and said second transformer primary coil, wherein said soft-magnetic core comprises an array of interleaved phase coils, wherein said second transformer primary coil is a return path for said first transformer primary coil, wherein said second transformer secondary coil is a return path for said first transformer secondary coil.
